(19) United States
(12) Patent Application Publication
(10) Pub. No.: US 2021/0155499 A1
(43) Pub. Date: May 27, 2021

(54) METASTABLE TODOROKITE CHANNELS

(71) Applicant: Alliance for Sustainable Energy, LLC, Golden, CO (US)

(72) Inventors: Lauren Marie GARTEN, Alexandria, VA (US); David Samuel GINLEY, Evergreen, CO (US)

(21) Appl. No.: 17/048,257

(22) PCT Filed: Apr. 23, 2019
(86) PCT No.: PCT/US19/28623

§ 371 Date: Oct. 16, 2020

Related U.S. Application Data
(60) Provisional application No. 62/661,168, filed on Apr. 23, 2018.
(60) Provisional application No. 62/662,363, filed on Apr. 25, 2018.

(51) Int. Cl. C01G 45/12; H01M 4/505; B01D 71/02

(52) U.S. Cl. CPC C01G 45/1228; H01M 4/505; C01P 2002/01; C01P 2002/72; B01D 71/024

(57) ABSTRACT

The present disclosure relates to a device comprising todorokite constructed of octahedra of manganese oxide forming a channel, wherein the channel contains a plurality of alkali ions but does not contain crystalline water molecules. In some aspects of the present disclosure, one of the alkali ions is magnesium and the channel may have a diameter of approximately one nanometer.

### CROSS-REFERENCED APPLICATIONS

This application claims the benefit of U.S. Provisional Application No. 62/661,168 filed Apr. 23, 2018 and U.S. Provisional Application No. 62/662,363 filed Apr. 25, 2018, the contents of which are incorporated herein by reference in their entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

Manganese oxides have been studied for their use as catalytic materials and in battery and filter applications. Manganese oxide polymorphs such as hollandite, cryptomelane, manjiroite, and coronadite consist of MnO₆ octahedra in double chains in a two-by-two structure. They are particularly useful as shape selective catalysts and molecular sieves. See U.S. Pat. No. 5,340,562.

Todorokite is a colloquial mineral name for a manganese oxide polymorph with channels which typically have a three-by-three array of edge-sharing manganese octahedra, although channel dimensions may vary. Todorokite octahedra form three-by-three channels that contain alkali ions and water molecules. Todorokite is prevalent in deep ocean mineral deposits. It has the largest channel dimension of any manganese oxide polymorph, with the possibility of use for intercalation, filtration, or storage.

### SUMMARY

An aspect of the present disclosure is a composition composed of a first string of three manganese oxide octahedra, a second string of three manganese oxide octahedra, a third string of three manganese oxide octahedra, and a fourth string of three manganese oxide octahedra, where the first string, the second string, the third string, and the fourth string form a channel, and an alkali ion is contained within the channel. In some embodiments, the channel may have a diameter that is approximately one nanometer. In some embodiments, the channel may be capable of battery intercalation.

A second aspect of the present disclosure is a method including preparing a mineral, such as todorokite, comprising octahedra of manganese oxide forming a channel, where the channel contains water, removing the water from the channel, and utilizing the mineral. In some embodiments, the mineral may be utilized for battery intercalation, storage, and/or filtration.

In some embodiments, the water may be removed from the channel by heating the mineral. The mineral may be heated to a temperature greater than 200° C. The mineral may be heated using a box furnace.

In some embodiments, the water may be removed from the channel by placing the mineral in a vacuum. The vacuum may be at a pressure of 10⁻³ torr.

In some embodiments, the water may be removed from the channel by heating the mineral and placing the mineral in a vacuum. This may occur simultaneously. The mineral may be heated to a temperature greater than 200° C. and the vacuum may be maintained at a pressure of 10⁻³ torr.

### BRIEF DESCRIPTION OF THE DRAWINGS

Exemplary embodiments are illustrated in referenced figures of the drawings. It is intended that the embodiments and figures disclosed herein are illustrative rather than limiting.

FIG. 1 illustrates a todorokite, according to some embodiments of the present disclosure.

FIG. 2 illustrates a method of preparing a todorokite and then removing crystalline water while maintaining the channel structure, according to some embodiments of the present disclosure.

FIG. 3 illustrates temperature programmed desorption spectroscopy (TPDS) data for heating a todorokite sample according to some embodiments of the present disclosure.

FIG. 4 illustrates a selected area electron diffraction (SAED) image of a todorokite sample post anneal.

FIG. 5 illustrates a transmission electron microscopy (TEM) image (along the channels) of a todorokite sample post anneal.

FIG. 6 illustrates an x-ray diffraction (XRD) graph during annealing.

REFERENCE NUMBERS

| | |
|---|---|
| 100 | todorokite structure |
| 110 | manganese oxide |
| 120 | water molecule |
| 130 | magnesium ion |
| 140 | channel |
| 200 | method |
| 210 | preparing todorokite |
| 220 | heating todorokite |
| 230 | utilizing todorokite |

### DETAILED DESCRIPTION

The present disclosure may address one or more of the problems and deficiencies of the prior art discussed above. However, it is contemplated that some embodiments as disclosed herein may prove useful in addressing other problems and deficiencies in other technical areas. Therefore, the embodiments described herein should not necessarily be construed as limited to addressing any of the particular problems or deficiencies discussed herein.

The present disclosure relates to a form of todorokite with crystalline water molecules removed and methods for removing crystalline water molecules from todorokite. The methods disclosed herein enable the preparation of todorokite, removal of crystalline water from the todorokite, and the utilization of the todorokite channel with crystalline water molecules removed in battery or filter applications. The present disclosure includes unexpected results as the channel remains stable after the removal of crystalline water molecules (as a metastable material), allowing the alkali ions to be intercalated or the channel to serve as a filter.

As used herein, crystalline water molecules refer to water molecules which are typically a part of the structure of todorokite. These water molecules are widely thought to prevent naturally made and synthetic todorokite from being a viable option for battery intercalation. Previous attempts to remove the water molecules to allow the todorokite to be used for battery and filtration applications have resulted in the channel collapsing. The present disclosure maintains the structure of the channel while removing the water, allowing for practical uses of todorokite.

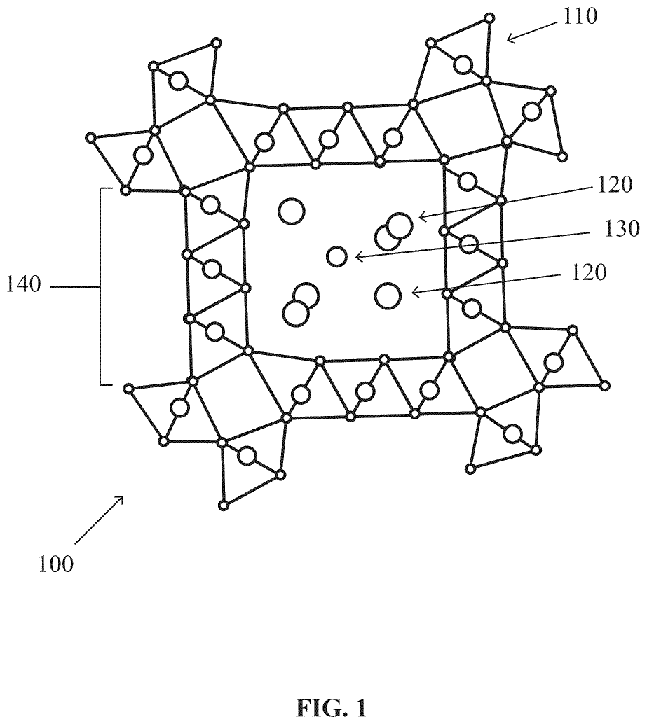

Despite having the largest channel size of any manganese oxide polymorph (a diameter of approximately one nanometer), todorokite has previously not been shown to be effective as a battery or filter. This is because the crystalline water bound inside of the channels inhibits any further intercalation of alkali ions. The crystalline water is believed to assist in maintaining the open crystal structure. It has been reported that the crystalline water molecules contribute to the structural stability of the channels by serving as interlayer pillars. In this present disclosure, it has been shown that the crystalline water molecules may be removed from the todorokite and that the channel may remain open without the crystalline water to be used as a battery or filter. Todorokite is a product of oxidation and leaching of manganese carbonate and silicate materials and rarely occurs in nature. This is because forming the unique todorokite channel structure requires a large amount of energy, so most industry-usable todorokite is created artificially. In nature, todorokite exists as poorly crystalized particles on a nanoscale level. The low content and poor crystallinity limit the potential applications of todorokite structures FIG. 1 illustrates the structure of a representative channel in todorokite 100.

Todorokite 100 is comprised of manganese oxide (MnO₆) 110 molecules arranged in a three-by-three array creating a channel 140. The channel 140 contains water molecules 120 and a magnesium (Mg²⁺) ion 130 as well as other alkali or alkaline earth ions (not shown). Todorokite is comprised of many of these channels arranged in arrays. The todorokite structure 100 may have a diameter of approximately one (1) nanometer. That is, the diameter may be between 3 nm and 0.2 nm. The diameter may be the “height” of the channel 140. The methods as described herein may be used on todorokite as depicted in FIG. 1.

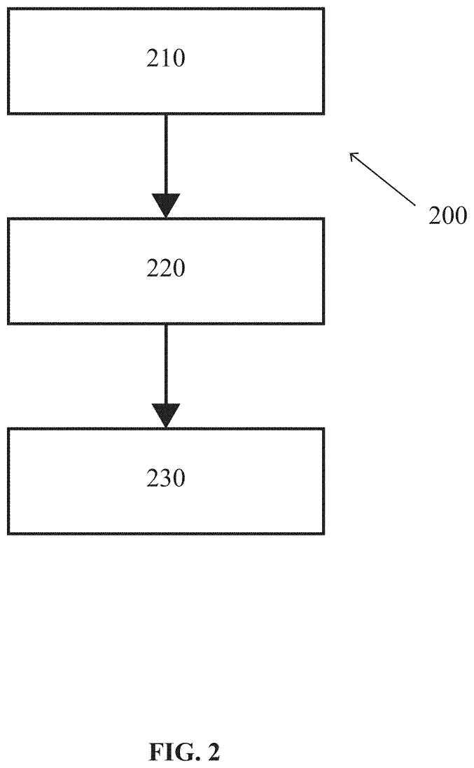

FIG. 2 illustrates the method 200 of removing crystalline water molecules from todorokite channels according to some embodiments of the present disclosure. The method 200 may begin with the preparation 210 of todorokite. In some embodiments, the preparation of todorokite 210 may include locating a naturally occurring sample of todorokite. In other embodiments, the preparation 210 of todorokite may involve synthetically making todorokite by first using a solution process to make a layered precursor phase of todorokite, such as birnessite. Next, the layered precursor may be put through an ion-exchange process and placed in an autoclave with water. The autoclave may subject the layered precursor to an elevated pressure and high temperature. The high pressure may result in the layered precursor forming the channels which are distinctive to todorokite. In some embodiments, the preparation 210 of the todorokite may be done using a hydrothermal process. The hydrothermal process to prepare 210 todorokite results in a powder form of todorokite. The powder may be pressurized using a die press to create larger conglomerates. In some embodiments, the preparation of todorokite 210 may include locating a naturally occurring layer precursor phase of todorokite, such as birnessite, and converting it to todorokite using a hydrothermal process.

After preparation 210, the crystalline water may be removed from the todorokite 220. Some or all of the crystalline water may be removed from the todorokite 220. Removing the crystalline water 220 from the todorokite may be performed on the powder todorokite or on larger conglomerated todorokite. In some embodiments, the crystalline water may be removed 220 by heating the todorokite. In some embodiments the crystalline water may be removed by exposing the todorokite to a chamber with a pressure below atmospheric pressure (i.e., a vacuum chamber). In some embodiments, the crystalline water may be removed 220 by a combination of heating the todorokite and exposing it to a vacuum.

To remove the crystalline water molecules 220, the todorokite may be heated to at least 200° C. and less than 300° C. This temperature range may allow the removal the crystalline water molecules but to ensure the structural integrity of the channel. Temperatures above 300° C. may result in the structural breakdown of the channel, although they may be used for large quantities of todorokite. The heating may be performed using a box furnace or other heating device. The todorokite may be heated to at least 200° C. for a period of time. The period of time of the heating may depend on the size of the todorokite being used and may be under two hours. For example, approximately 250 mg of todorokite may be heated for less than two minutes. Longer heating times may result in the structural breakdown of the channel. Structural breakdown of the channel prevents the channel from being utilized for intercalation of alkali ions, filtering purposes, or electrochemical storage. To preserve the structure of the channel, the todorokite may be annealed, meaning it may be heated and allowed to cool slowly.

To remove the crystalline water molecules 220, the todorokite may be exposed to a slow vacuum process to remove the crystalline water molecules. The vacuum may be 10⁻³ torr and the todorokite may be exposed to the vacuum for up to 24 hours. The vacuum may be provided using an autoclave or pressure chamber.

After the crystalline water has been removed 220, the todorokite may be utilized 230 in various applications. Examples of potential applications include the intercalation of alkali metals in electrochemical storage, filter of nano-scale materials, such as certain bacteria, viruses, or hydrocarbons and/or electrochemical or hydrogen storage. The absence of crystalline water molecules 120 in the channel 140 may allow the intercalation of alkali ions or for the channel to act as a filter and/or electrochemical storage medium. The unique channel size of a diameter of approximately one nanometer may allow the todorokite to filter large ions, hydrocarbons, bacteria, and/or viruses.

In some embodiments, the todorokite with water removed may comprise manganese oxide octahedral molecular sieves arranged in a three-by-three or three-by-four array.

### Thermochemical Preparation of Todorokite and Removal of Crystalline Water

Samples of todorokite were prepared using a thermochemical process. 1.89 g of magnesium chloride (MnCl₂) was dissolved in 40 mL of distilled deionized (DDI) water (10 ΩM) under constant stirring. 2.4 g of sodium hydroxide (NaOH) was dissolved in 50 mL of DDI water. The NaOH solution was slowly added in a dropwise method in the MnCl₂ solution. The mixture was stirred at 500 rpm for 10 minutes. Then 10 mL of hydrogen peroxide (H₂O₂) was added in a dropwise method to the mixture. The mixture was then heated to 100° C. and maintained at that temperature of one hour with constant stirring at 1100 rpm. The precipitates were vacuum filtered and then re-dispersed into a solution of 4 g of NaOH dissolved in 50 mL of DDI water. The mixture was heated to 200° C. with constant stirring at 500 rpm for 18 hours. The mixture was washed with deionized (DI) water until it reached a neutral pH and was filtered, then left at room temperature overnight. This resulted in a powder of a layered sodium magnesium oxide (NaₓMnO₂), known colloquially as birnessite.

For todorokite synthesis/preparation the dried NaₓMnO₂ was filtered into 2 M of MgCl₂ in 100 mL of DDI water at room temperature with stirring at 1000 rpm for 48 hours. The precipitate was washed five times. The precipitate was separated into 1 g samples. Each 1 g sample was added to 1 M MgCl₂ in Teflon vessels containing 30 mL of DDI water. Todorokite, MgxMnO₂ was prepared using a hydrothermal method at 160° C. for 24 hours. The final todorokite was filtered, washed, and left to dry at room temperature overnight.

Due to the size constraints of the reactor, todorokite was produced in batches of approximately 250 mg. In total twenty-five to thirty batches of todorokite were created. Initial testing was performed on individual batches of todorokite, but later tests were performed on combinations of powder from multiple reasonably consistent batches of todorokite, for a total sample weight of approximately two grams. The thermochemical process typically results in a powder form of todorokite. The powder may be conglomerated into solids using a die press and/or autoclave. A die press may apply approximately 2,000 psi of force to the powder. The form of the todorokite (i.e., powder or conglomerate) does not impact the use of the present disclosure.

The todorokite were heated to approximately 250° C. Previous testing showed that heating to 300-350° C. would result in significant structural changes to the channel structure of the todorokite. These changes may prevent the todorokite from being used a filter and/or battery and could cause the channel to collapse. The todorokite were exposed to the heat for approximately two minutes and then allowed to return to room temperature.

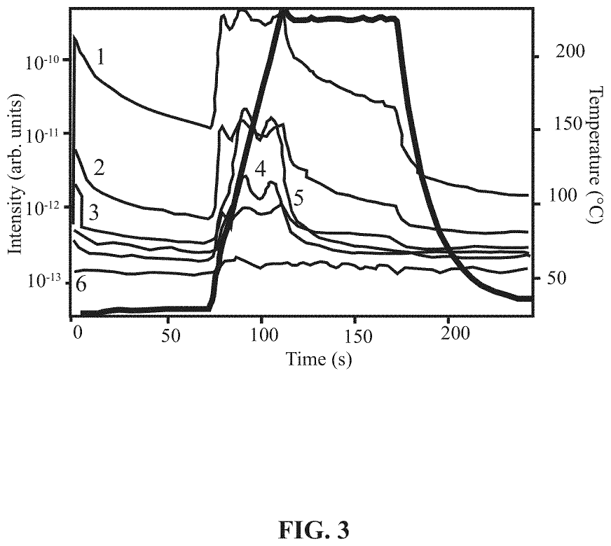

To verify the crystalline water molecules were removed during this heating process, the todorokite were analyzed by temperature programmed desorption spectroscopy (TPDS). Analysis by TPDS provides information about the rate of desorption and what molecules are desorbed. For the present disclosure, the focus was on water desorption of the todorokite. FIG. 3 shows the TPDS graph for the todorokite after the heating described above. FIG. 3 shows that as the temperature (indicated by the thick, solid line) of the todorokite was increased, the crystalline water molecules evaporated from the channel (as shown by the temperature line and the water line 1). The lines are a first water (H₂O) 1, hydrogen (H₂) 2, a second water (H₂O) 3, carbon monoxide (CO) 4, carbon dioxide (CO₂) 5, and oxygen (O₂) 6. The todorokite was heated to 250° C. for less than two minutes. It was determined that longer heating time or heating the todorokite to a larger temperature causes the channels to collapse and not be usable as filters or batteries. The first water 1, may be water on the surface of the todorokite; the second water 2 may be crystalline water imbedded in the todorokite structure. TPDS graphs are weight-specific and the chart in FIG. 3 indicates that water is being removed from the todorokite mineral and at what temperature the water is removed.

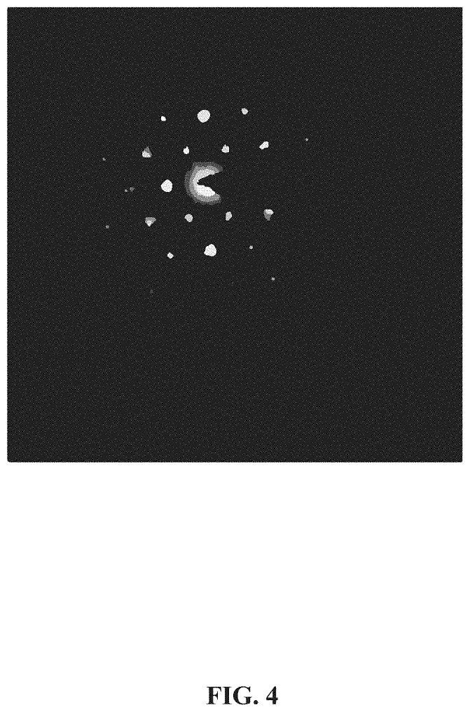

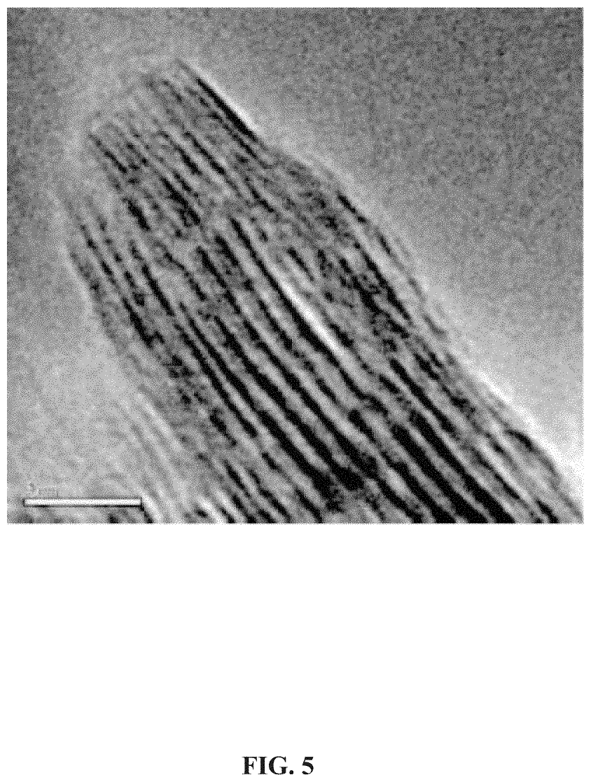

The structure of the todorokite material was measured before and after the removal of crystalline water molecules by x-ray diffraction (XRD), selected area electron diffraction (SAED), and transmission electron microscopy (TEM). FIG. 4 shows the SAED for films after the removal of water, with peaks consistent with the todorokite structure. The structure of the approximately one (1) nm channels is clearly seen in the edge view taken by TEM shown in FIG. 5. The TEM in FIG. 5 shows that the todorokite structure is still intact after the water has been removed from the structure.

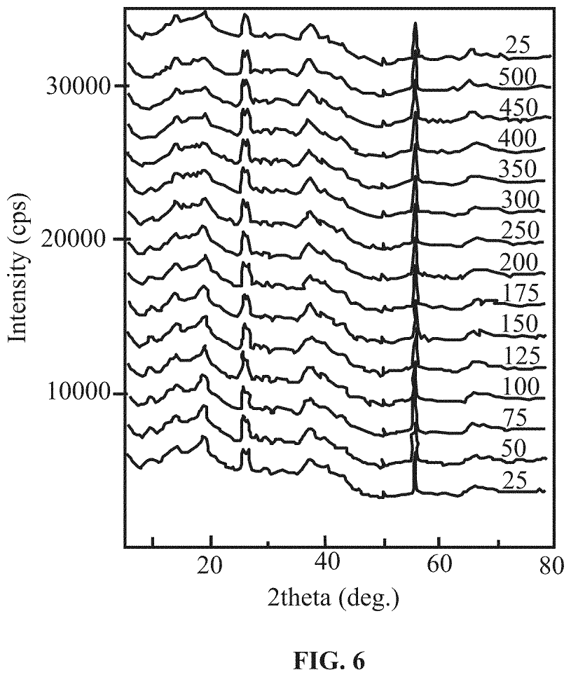

FIG. 6 shows the x-ray diffraction taken as a function of temperature of a todorokite sample after crystalline water removal from 25° C. to 500° C. and then returning to 25° C. There are no observable changes in the structure that occur from room temperature up until approximately 350° C., despite the TPDS showing the removal of water in this temperature range. This indicates that the structure is maintained to approximately 350° C. even though the crystalline water was removed. After 350° C. the intensity peaks begin to flatten between 10° and 20°, indicating some degrading of the sample. However, when the sample was returned to 25° C. these intensity peaks returned, indicating the degradation was not permeant.

The todorokite maintained a channel diameter of approximately one nanometer after the removal of the crystalline water molecules. This size allows the todorokite to be used for the intercalation of magnesium, other alkali, and/or alkaline earth ions in the channel. It also allows the todorokite to filter materials which current filter channels are too small to capture. Todorokite channels without crystalline water molecules may also facilitate electrochemical storage.

### Composition Examples

1. A composition comprising:

a first string of three manganese oxide octahedra;

a second string of three manganese oxide octahedra;

a third string of three manganese oxide octahedra; and

a fourth string of three manganese oxide octahedra; wherein:

the first string, the second string, the third string, and the fourth string form a channel, and

an alkali ion is contained within the channel.

2. The composition of Example 1, wherein:

the alkali ion is magnesium.

3 The composition of Example 1, wherein:

the alkali ion is calcium.

4. The composition of Example 1, wherein:

the alkali ion is sodium.

5. The composition of Example 1, wherein:

the alkali ion is potassium.

6. The composition of Example 1, wherein:

the channel has a diameter of approximately one nanometer.

7. The composition of Example 6, wherein the channel is capable of battery intercalation.

### Method Examples

1. A method comprising:

preparing a todorokite comprising octahedra of manganese oxide forming a channel, wherein the channel contains water,

removing the water from the channel, and

utilizing the todorokite.

2. The method of Example 1, wherein the water is removed from the channel by heating the todorokite.
3. The method of Example 2, wherein the todorokite is heated to a temperature greater than 200° C.
4. The method of Example 2, wherein the todorokite is heated to a temperature less than 300° C.
5. The method of Example 2, wherein the todorokite is heated for less than two minutes.
6. The method of Example 2, wherein the todorokite is heated using a box furnace.
7. The method of Example 1, wherein the water is removed from the channel by placing the todorokite in a vacuum.
8. The method of Example 7, wherein the todorokite is placed in the vacuum for less than 24 hours.
9. The method of Example 7, wherein the vacuum is 10⁻³ torr.
10. The method of Example 1, wherein the water is removed from the channel by heating the todorokite and placing the todorokite in a vacuum.
11. The method of Example 10, wherein the todorokite is heated to a temperature greater than 200° C.
12. The method of Example 10, wherein the vacuum is 10⁻³ torr.
13. The method of Example 10, wherein the vacuum is greater than 10⁻³ torr.
14. The method of Example 10, wherein the vacuum is less than 10⁻³ torr.
15. The method of Example 1, wherein the todorokite is utilized for battery intercalation.
16. The method of Example 1, wherein the todorokite is utilized for filtration.
17. The method of Example 1, wherein the todorokite the utilized for storage.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an invention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a first string of three manganese oxide octahedra;
a second string of three manganese oxide octahedra;
a third string of three manganese oxide octahedra; and
a fourth string of three manganese oxide octahedra; wherein:
the first string, the second string, the third string, and the fourth string form a channel, and
an alkali ion is contained within the channel.

2. The composition of claim 1, wherein:
the channel has a diameter of approximately one nanometer.

3. The composition of claim 2, wherein the channel is capable of battery intercalation.

4. A method comprising:
preparing a todorokite comprising octahedra of manganese oxide forming a channel, wherein the channel contains water,
removing the water from the channel, and
utilizing the todorokite.

5. The method of claim 4, wherein the todorokite is utilized for battery intercalation.

6. The method of claim 4, wherein the todorokite is utilized for filtration.

7. The method of claim 4, wherein the todorokite the utilized for storage.

8. The method of claim 4, wherein the water is removed from the channel by heating the todorokite.

9. The method of claim 8, wherein the todorokite is heated to a temperature greater than 200° C.

10. The method of claim 8, wherein the todorokite is heated using a box furnace.

11. The method of claim 4, wherein the water is removed from the channel by placing the todorokite in a vacuum.

12. The method of claim 11, wherein the vacuum is 10⁻³ torr.

13. The method of claim 4, wherein the water is removed from the channel by heating the todorokite and placing the todorokite in a vacuum.

14. The method of claim 13, wherein the todorokite is heated to a temperature greater than 200° C.

15. The method of claim 14, wherein the vacuum is 10⁻³ torr.
